(19) United States
(12) Patent Application Publication
(10) Pub. No.: US 2010/0188336 A1
(43) Pub. Date: Jul. 29, 2010

(54) FINGER COMPUTER MOUSE

(76) Inventors: Kai Kong Ng, Singapore (SG); Kai Cheong Ng, Singapore (SG)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/440,239

(22) PCT Filed: Sep. 5, 2007
(86) PCT No.: PCT/SG07/00290

§ 371 Date: Mar. 5, 2009

(30) Foreign Application Priority Data
Sep. 5, 2006 (SG) 200605958-8
Sep. 5, 2006 (SG) 200605959-6

(51) Int. Cl. G09G 5/08; G06F 3/033

(52) U.S. Cl. 345/163; 345/166

(57) ABSTRACT

A finger computer mouse for mounting on and operation by a finger, the finger computer mouse comprising a body having a first end and a second end; a first switch at the first end and a second switch at one of the second end and intermediate the first and second ends; operation of the first switch being the equivalent of a right click and operation of the second switch being the equivalent of a left click.

### FIELD OF THE INVENTION

This invention relates to a finger computer mouse and refers particularly, though not exclusively, to a finger computer mouse able to be used more intuitively.

### BACKGROUND OF THE INVENTION

As shown in FIG. 1, a normal computer mouse has left and right buttons and a scroll wheel. A constant grip is required to manipulate the mouse. There may be extra buttons on the side of the mouse such as, for example, right and left double click buttons. Many people find using such a mouse awkward due to, for example, arthritis. They are also bulky and difficult to store for travel when used with laptop or notebook computers. Furthermore, they require a relatively large, smooth, flat area on which they can operate. This is normally the top of a desk, table or bench. Often a pad must be used with the mouse for correct operation.

A smaller, more easily used and/or more easily transported and/or more intuitive mouse would be of considerable advantage.

### SUMMARY OF THE INVENTION

According to a first preferred aspect there is provided a finger computer mouse for mounting on and operation by a finger, the finger computer mouse comprising a body having a first end and a second end; a first switch at one of the first end and intermediate the first and second ends, and a second switch at the second end; operation of the first switch being the equivalent of a right click and operation of the second switch being the equivalent of a left click.

According to a second preferred aspect there is provided a finger computer mouse comprising a body having a first end and a second end, a first switch at one of the first end and intermediate the first and second ends, and a second switch at the second end; wherein the finger computer mouse can be oriented in a first orientation with a finger located operatively above the first switch and the second switch, and a second orientation with a first finger located operatively above the first switch and a second finger located operatively above the second switch; the first orientation being by rotation of the finger computer mouse by substantially 90°.

According to a third preferred aspect there is provided a finger computer mouse for mounting on and operation by a finger, the finger computer mouse comprising a body having a first end and a second end; a first switch at one of the first end and intermediate the first and second ends, and a second switch at the second end; and a pivot between the first end and the second end for enabling selective operation by the finger of one of the first switch and the second switch.

According to a fourth preferred aspect there is provided a finger computer mouse for mounting on and operation by a finger, the finger computer mouse comprising a body having a first end and a second end; a first switch at one of the first end and intermediate the first and second ends, and a second switch at the second end; at least one support strip extending from the first end to the second end; a ring extending from the body to above the at least one support strip; the at least one support strip being biased away from the body for releasably retaining the finger between the ring and the at least one support strip.

According to a fifth preferred aspect there is provided a finger computer mouse for mounting on and operation by a finger, the finger computer mouse comprising a body having a first end and a second end; a first switch at one of the first end and intermediate the first and second ends, and a second switch at the second end; at least one support strip extending from the first end to the second end; the at least one support strip being curved and biased away from the body for supporting the finger in a curved manner when the finger computer mouse is fitted to the finger.

For one or more of the five aspects the first end may be raised relative to the second end, and the second end may be lowered relative to the first end. Operation of the first switch may be the equivalent of a right click and operation of the second switch may be the equivalent of a left click. The finger computer mouse may be oriented in a first orientation with a finger located operatively above the first switch and the second switch, and a second orientation with a first finger located operatively above the first switch and a second finger located operatively above the second switch; the first orientation being 90° from the second orientation. A pivot may be provided between the first end and the second end for enabling selective operation by the finger of one of the first switch and the second switch. At least one support strip may be provided extending from the first end to the second end. A ring may be provided extending from the body to above the at least one support strip. The at least one support strip may be biased away from the body for releasably retaining the finger between the ring and the at least one support strip. The at least one support strip may be curved and biased away from the body for supporting the finger in a curved manner when the finger computer mouse is fitted to the finger. A cable may extend from the one of: the first end and the second end. There may be a connector at an end of the cable remote from the finger computer mouse. The connector may be able to be located between the at least one support strip and the ring when the finger computer mouse is not in use. The body may have a lower face, a diode for light emission may be mounted within the body for generating a beam of light for passing directly through a first opening in the lower face and onto a surface for reflection by the surface; there being a second opening in the lower face, and an optical sensor mounted in the body adjacent the lower face for receiving the reflected beam through the second opening. The first opening and the second opening may be formed into a single opening. A laser diode may be provided for generation of a laser beam for acting as a pointer. The pivot may depend from the body or may extend upwardly from an upper surface of the body. The pivot may extend laterally of the body between the first end and the second end. The pivot may be of a height greater than the height of each of the first switch and the second switch. There may be two support strips. The first switch may depend from the body. The second switch may depend from the body. Alternatively, the first switch may extend upwardly from the body. The second switch may extend upwardly from the body. At least one of the first end and the second end may act as a pivot for the finger. The first end and the second end may each have a cowling that comprises the pivot at the first end and the second end respectively.

### BRIEF DESCRIPTION OF THE DRAWINGS

In order than the invention may be fully understood and readily put into practical effect there shall now be described by way of non-limitative example only preferred embodiments of the present invention, the description being with reference to the accompanying illustrative drawings.

In the drawings:

FIG. 1 is a perspective view of a typical prior art computer mouse;

FIG. 2 is a side view of a first preferred embodiment on a finger;

FIG. 3 is a side view of the first preferred embodiment;

FIG. 4 is a side view of the first preferred embodiment illustrating the operation action;

FIG. 5 is an illustration of four different pivot arrangements for the first preferred embodiment;

FIG. 6 is a top perspective view of the first preferred embodiment in a second orientation;

FIG. 7 is an illustration of the use of the first preferred embodiment on an adjustable plane;

FIG. 8 is an illustration of the use of the first preferred embodiment on a body;

FIG. 9 is an illustration of the insertion and removal of a finger with the first preferred embodiment;

FIG. 10 is an illustration of the first preferred embodiment in a stowed configuration;

FIG. 11 contains three illustrations of the use of the first preferred embodiment with three different forms of computer devices;

FIG. 12 is an illustration of a modified form of one of the devices of FIG. 11;

FIG. 13 is a schematic side view of the optical system of a prior art mouse, and an optical system of a third preferred embodiment;

FIG. 14 is an illustration of a fourth preferred embodiment; and

FIG. 15 is an illustration of a fifth preferred embodiment.

### DETAILED DESCRIPTION OF THE PREFERRED EMBODIMENTS

The first preferred embodiment of FIGS. 2 to 5 is a finger computer mouse 10 that requires the use of only one finger 12 to perform the functions of a typical computer mouse. The mouse 10 is releasably held on the finger 12 by a ring 14. The functions able to be performed include:
(a) controlling the cursor movement on a computer screen;
(b) performing left and right button clicks; and
(c) scrolling.

By using a single finger 12 the need to provide a constant grip in order to point and move a screen cursor is eliminated. This reduces the biomechanical stress on a users hand, wrist and arm; and helps to reduce fatigue, discomfort and pain that may result from prolonged use. The use of the ring 14 also assists users as there is no force required to be exerted by the user to hold the mouse 10 on the finger 12.

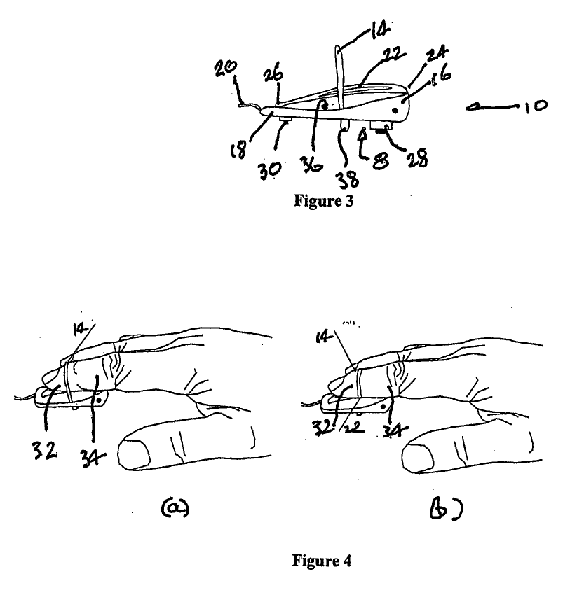

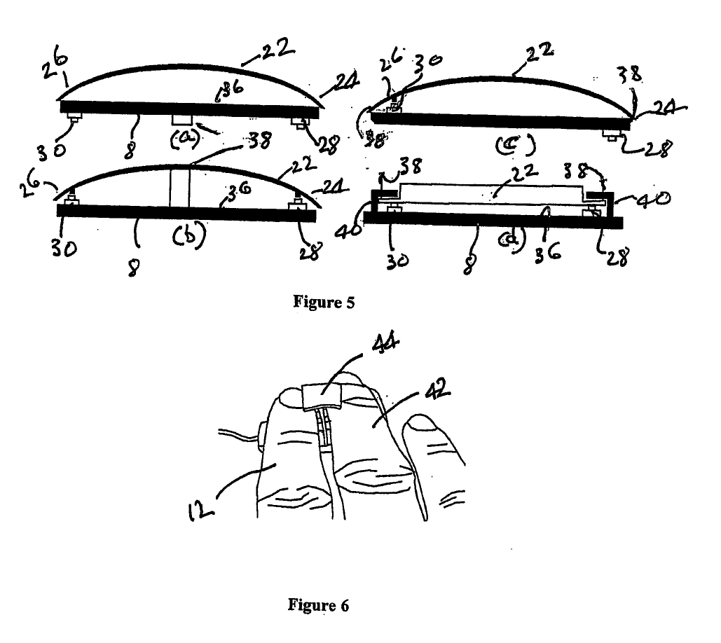

As shown in FIGS. 3 and 4, the mouse 10 has a body 8 that contains all of the required electrical functionality of the mouse 10. The body 8 has a raised first end 16 and a lowered second end 18. The first end 16 is raised relative to the second end 18, and the second end 18 is lowered relative to the first end 16. The send end 18 may be at substantially the same level as the main portion of the body 8, or may be slightly higher or lower than the main portion of the body 8. If a cable connection is used, the cable 20 is connected to the mouse 10 at the lowered second end 18. As such, the lowered second end 18 is the “front” of the mouse 10 and the raised first end 16 is the rear of the mouse 10. Extending over the body 8 from the raised first end 16 to the lowered second end is at least one, and preferably two, support strips 22. The support strips 22 at a first end 24 thereof may be used to activate a first switch 28 (FIG. 5) and at the second end 26 thereof may be used to activate a second switch 30. The support strips 22 are preferably spring support strips that are biased away from body 8 and towards the ring 14 so that they can be depressed slightly when inserting finger 12 under ring 14, and to provide a holding force between ring 14 and finger 12 to prevent the mouse 10 from accidentally disengaging finger 12.

Alternatively, one of the switches 28, 30 may be located centrally of the mouse 10 and intermediate the first end 16 and the second end 18. Further alternatively or additionally, one of the switches 28, 30 may be a sliding switch at the second end 26 of support strip 22. The slider switch may be biased to an inactive position in the normal manner. The slider switch may be pulled by finger 12 to operate as this is closest to the normal “click” function. Release of the slider switch is akin to releasing a switch on known mice. Alternatively, the slider switch may be pushed to operate and released to return to the normal position. Further alternatively, the cable 20 may be connected at the first end 16. The use of “at” in relation to an end is to be taken as including adjacent the end.

By having the support strip 22 curved, and first end 16 higher than second end 18, the finger 12 adopts the usual curved configuration that facilitates ease of use.

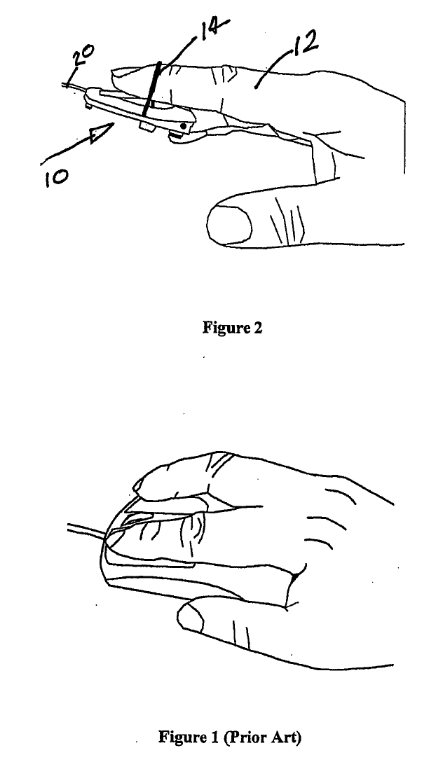

Therefore, by using the ball 32 of the finger 12 to press on support strip 22 at the second end 26 thereof the second switch 30 can be activated. This is a very intuitive movement and thus the second switch 30 is preferably the direct equivalent of activating the left button on the mouse of FIG. 1. By using the middle portion 34 of the finger 12, the first end 24 of the support strip 22 can be pressed to activate the first switch 28. As this is not as intuitive as using the ball 32, this is preferably the direct equivalent of the activating of the right button on the mouse of FIG. 1.

Therefore, the typical right and left buttons of the mouse of FIG. 1 are now implemented using first switch 28 and second switch 30. A simple rocking action of the finger 12 allows a user to perform button clicks. As the switches 28, 30 are arranged longitudinally of the mouse 10 rather than laterally, as has been normal, the mouse 10 is equally suitable for both right-handed and left-handed use. In addition, the mouse 10 can be used on any of the eight fingers, and possible even the two thumbs. This allows a user to use different fingers to avoid stress on any one finger over a prolonged period. The mouse 10 is held on the finger 12 by the ring 14. The ring 14 may be securely attached to the body 8, or may be separable from the body 8. In the latter case, the ring 14 may be releasably attachable to the body 8 by a snap fit, bayonet fitting, magnets, or any other suitable releasable attachment mechanism. The ring 14 may be pivotally attached to the body 8 so that it can be pivotally moved to a position where it is substantially parallel to the top surface 36 of the body 8.

To prevent accidental operation of both switches 28, 30 at the one time, and as shown in FIG. 5, at least one pivot 38 is provided. In FIG. 5(a) the pivot 38 depends from the body 8. The pivot 38 and extends laterally of the body 8 for at least a part of the width of the body 8. It may extend for substantially the complete width of the body 8. Also depending from the body 8 are the switches 28, 30. The pivot 38 is approximately half way between the two ends 16, 18 and is of a height at least as great as the switches 16, 18. In this way when the mouse 10 is on a surface, the pivot 38 will engage the surface. A pressure by the middle portion 34 of the finger 12 on the first end 24 of support strip 22 will cause the body 8 to pivot about the pivot 38 and the first switch 28 to engage the surface and thus actuate the first switch 38. A pressure by the ball portion 32 of the finger 12 on the second end 26 of the support strip 22 will cause body 8 to pivot about the pivot 38 and the second switch 30 to engage the surface and thus actuate the second switch 30.

The pivot 38, as well as the switches 28, 30 may be in different locations. In FIG. 5(b) the pivot 38 extends upwardly from the top surface 36 of the body 8, and also laterally of the body 8, as before. The switches 28, 30 also extend upwardly from the top surface 36. As can be seen, the pivot 36 is of a height greater than the switches 28, 30 and is located at the approximate centre of the body 8. In this way the body 8 does not pivot about the pivot 38, but remains “flat” on the surface. The support strip 22 pivots about the pivot 38 for activation of the switches 28, 30 in the same manner as described above.

In FIG. 5(c) the switches 28, 30 are on different surfaces of the body 8. The first switch 28 depends from the body 8, and the second switch extends upwardly from the top surface 36 of the body 8. The pivoting is therefore about the first end 16 and second end 18. No pivot 38 is required.

FIG. 5(d) has both switches 28, 30 extending upwardly from the top surface 36 of body 8 at each end of body 8. Opposed cowlings 40 extend over the ends 24, 26 of the support strip 22 to create pivot points for the finger 12 at each end of the mouse 10. Thus, by pivoting finger 12 on cowling 40 at second end 18, the ball 32 of finger 12 can press on the support strip 22 above or adjacent the second switch 30; and by pivoting on cowling 40 at the first end 16, the middle portion 34 of finger 12 can press on support strip 22 above or adjacent the first switch 28. In this form it is possible for finger 12 to press on support strip 22 intermediate the two ends 24, 26 of support strip 22 and thus attempt to simultaneously activate both of the switches 28, 30. Whichever was activated first would apply in the same manner as attempts at simultaneous right and left clicks on the mouse of FIG. 1. Again, no pivot 38 is required.

However, a pivot 38 of the form shown in FIG. 5(a) or (b) may be used with the forms of FIGS. 5(c) and (d), if required or desired.

For use of the switches 28, 30 as the normal left and right buttons, by rotating the mouse 10 such that second switch 30 is on the left of the first switch 28, the mouse 10 is able to act like the mouse of FIG. 1. The ring 14 provides a grip so that fingers 12, 42 can grip the ring 14 between them. In this format, the ring 14 may have a top pad 44 for facilitation of the gripping of the ring 14 by the fingers 12, 42. The top pad 44 may be a snap fit on the ring 14.

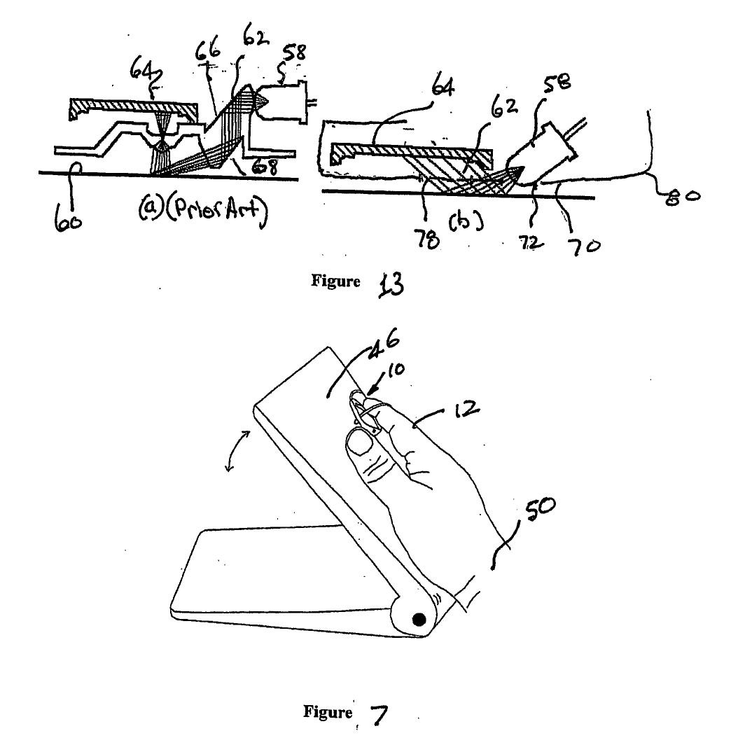

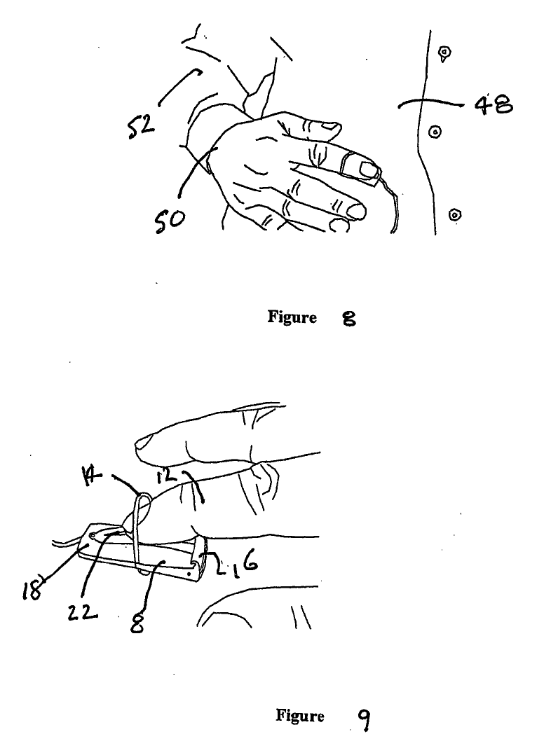

As shown in FIGS. 7 and 8 the mouse 10 is able to be used in any desired location. It may be used when seated at a desk, table or bench; when mobile; lying in bed; on an inclined surface 46; on the body 48; and so forth. It allows the straightening, unbending or untwisting of the wrist 50. This assists in reducing muscle tension created in the forearm 52 and allows the user to work at an angle that is the most comfortable and/or suitable.

As there may be a need for the user to alternate between a keyboard and the mouse 10, the mouse 10 may be used on any finger. This may allow a user who does not use all fingers when using the keyboard to have the mouse 10 on a finger even when using the keyboard. However, and as shown in FIG. 9, the user can remove the mouse 10 from finger 12 or place it on the finger 12 relatively easily by depressing the support strip 22 slightly before removing the finger 12 from, or inserting the finger 12 into, the ring 14. In this way the opening of the ring 14 enlarges, thus making insertion and removal of the finger easier. The spring nature of the support strip 22 also helps to hold the finger 12 in place in the ring 14, and restrain the mouse 14 from accidentally slipping from the finger 12.

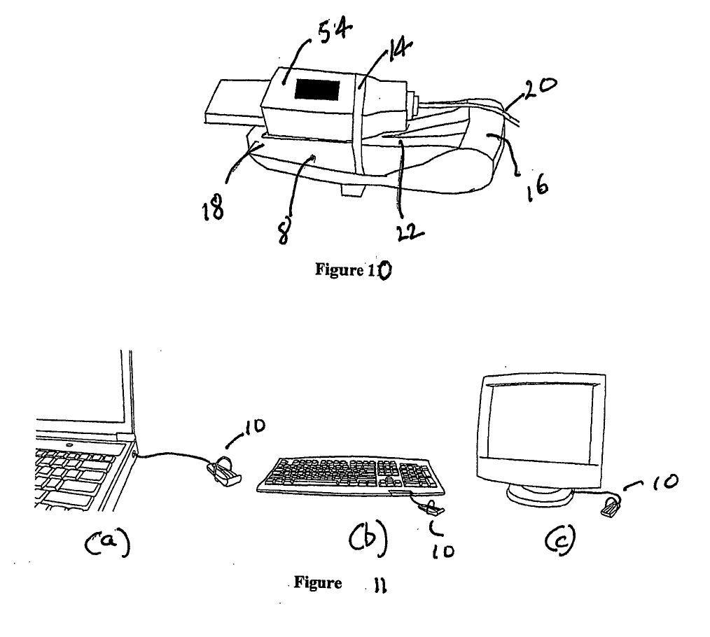

As is shown in FIG. 10, a connector 54 may be at the end of cable 20 remote from mouse 10. As shown, it is a USB connector 54. However, it may be any suitable or required connector. The connector 54 may be placed in the mouse 10 is the same manner as the finger 12 for releasably retaining the connector 46 relative to the mouse 10. This is of assistance in wire management. Magnets (not shown) may be used to hold the connector 54 relative to the mouse 10 for ease of management.

To further help with wire-management, the mouse 10 may be integrated with existing devices such as, for example, notebooks (FIG. 11(a)), keyboards (FIG. 11(b)), intelligent monitors (FIG. 11(c)), and other devices that have USB or other similar connectivity for enabling the mouse 10 to be operatively connected to the device. A retractable mechanism may be housed within the device, so that the cable 20 can be stored neatly when not in use. Again, magnets (not shown) may be used to hold the mouse 10 in place relative to the device. With the use of the mouse 10, the capacitive sensing touch pad of most notebooks come need not be used, or even supplied with the notebook. They can be replaced by the mouse 10.

Alternatively, instead of using a retractable device to wind and store the cable 20, a container 56 integral with the device may be used to house the mouse 10 when not in use.

FIG. 13(a) shows the optical and laser systems of mice presently used (such as that of FIG. 1). Light is generated by a light emitting diode or laser diode 58. To illuminate the surface 60 and to focus the beam of light 62 from the diode 58 onto an optical sensor 64, optical lenses 66, 68 are used. The lenses 66, 68 are usually made of transparent plastic, which needs to be highly polished and requires a precision manufacturing process. There is also a strict requirement in the placement of the lens. The lenses 66, 68 are relatively large and thus the mouse containing them must be correspondingly large.

FIG. 13(b) shows an embodiment where the light emitting diode or laser diode 58 is mounted in the body lower than in the prior art such that the diode is mounted on or adjacent the lower face 70 of the body 8. The light beam 62 passes through an opening 72 in the lower face 70 and is projected directly onto surface 60 by the diode 58 without the use of any intervening lenses. The reflected light beam 62 passes through a second opening 78 in the lower face 70 and is captured directly by the optical sensor 64, again without any intervening lenses. The optical sensor 64 can also be lower in the body 8 and thus be at or adjacent the lower face 70. Therefore, the overall height of the mouse 10 is able to be reduced. By using the lens of the diode 58 to control the light beam 62 and tilting the diode to about 45 degrees, the lenses 66, 68 can be removed. The openings 72, 78 may be formed into a single opening. A transparent or translucent cover may be placed over the openings 72, 78 if required or desired.

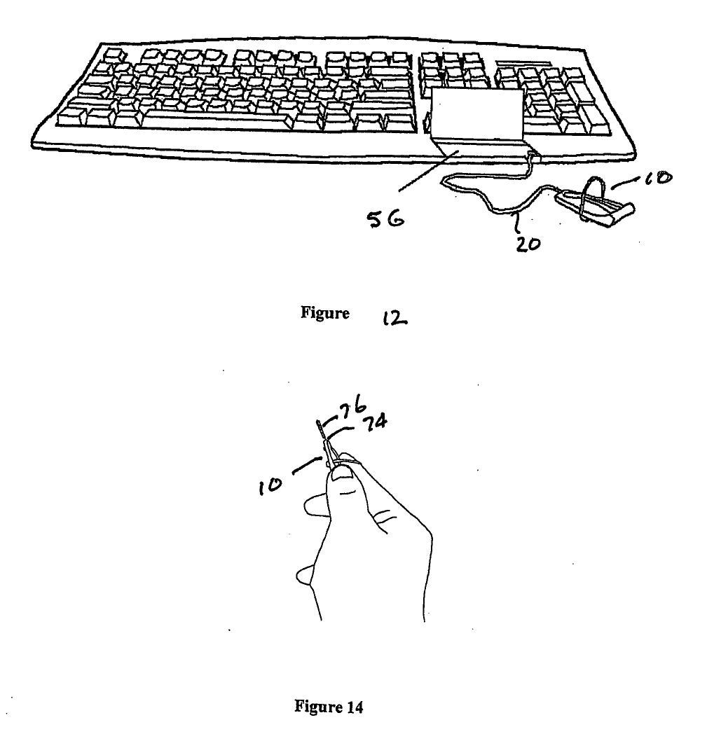

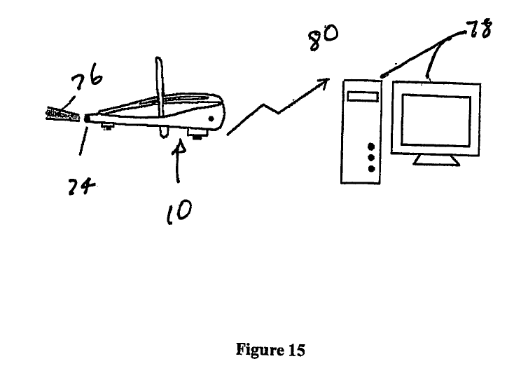

With its ease of use, small size and portability, the mouse 10 can easily be adapted for presentation purposes. With reference to FIGS. 14 and 15, a laser light diode 74 can be included in the mouse 10 for generating a beam 76 for use as a pointer during presentations. This can be implemented for both a wired and wireless version of the mouse 10. A microphone (not shown) may also be incorporated for a complete presentation package.

For a wireless version of the mouse 10, radio frequency signals 80 may be used to communicate with the computer 78 through its wireless USB device, wireless LAN, or proprietary wireless interface.

Whilst there has been described in the foregoing description preferred embodiments of the present invention, it will be understood by those skilled in the technology concerned that many variations in details of design, construction and/or operation may be made without departing from the present invention.

1. A finger computer mouse for mounting on and operation by a finger, the finger computer mouse comprising a body having a first end and a second end; a first switch at one of the first end and intermediate the first and second ends, and a second switch at the second end; operation of the first switch being the equivalent of a right click and operation of the second switch being the equivalent of a left click.

2. A finger computer mouse comprising a body having a first end and a second end, a first switch at one of the first end and intermediate the first and second ends, and a second switch at the second end; wherein the finger computer mouse can be oriented in a first orientation with a finger located operatively above the first switch and the second switch, and a second orientation with a first finger located operatively above the first switch and a second finger located operatively above the second switch; the first orientation being by rotation of the finger computer mouse by substantially 90°.

3. A finger computer mouse for mounting on and operation by a finger, the finger computer mouse comprising a body having a first end and a second end; a first switch at one of the first end and intermediate the first and second ends, and a second switch at the second end; a pivot between the first end and the second end for enabling selective operation by the finger of one of the first switch and the second switch.

4. A finger computer mouse for mounting on and operation by a finger, the finger computer mouse comprising a body having a first end and a second end; a first switch at one of the first end and intermediate the first and second ends, and a second switch at the second end; at least one support strip extending from the first end to the second end; a ring extending from the body to above the at least one support strip; the at least one support strip being biased away from the body for releasably retaining the finger between the ring and the at least one support strip.

5. A finger computer mouse for mounting on and operation by a finger, the finger computer mouse comprising a body having a first end and a second end; a first switch at one of the first end and intermediate the first and second ends, and a second switch at the second end; at least one support strip extending from the first end to the second end; the at least one support strip being curved and biased away from the body for supporting the finger in a curved manner when the finger computer mouse is fitted to the finger.

6. A finger computer mouse as claimed in any one of claims 1 to 5, wherein the first end is raised relative to the second end, and the second end is lowered relative to the first end.

7. A finger computer mouse as claimed in any one of claims 2 to 5, wherein operation of the first switch is the equivalent of a right click and operation of the second switch is the equivalent of a left click.

8. A finger computer mouse as claimed in any one of claims 1 or 3 to 5, wherein the finger computer mouse can be oriented in a first orientation with a finger located operatively above the first switch and the second switch, and a second orientation with a first finger located operatively above the first switch and a second finger located operatively above the second switch; the first orientation being 90° from the second orientation.

9. A finger computer mouse as claimed in any one of claims 1, 2, 4 or 5 further comprising a pivot between the first end and the second end for enabling selective operation by the finger of one of the first switch and the second switch.

10. A finger computer mouse as claimed in any one of claims 1 to 3 or 5 further comprising at least one support strip extending from the first end to the second end; a ring extending from the body to above the at least one support strip; the at least one support strip being biased away from the body for releasably retaining the finger between the ring and the at least one support strip.

11. A finger computer mouse as claimed in any one of claims 1 to 4 further comprising at least one support strip extending from the first end to the second end; the at least one support strip being curved and biased away from the body for supporting the finger in a curved manner when the finger computer mouse is fitted to the finger.

12. A finger computer mouse as claimed in any one of claims 1 to 3, 10 or 11, wherein the at least one support strip extends over the body and is curved and biased away from the body.

13. A finger computer mouse as claimed in claim 12 further comprising a ring extending upwardly from the body; a cable extending from an end of the body; and
a connector at an end of the cable remote from the finger computer mouse;
wherein the connector is able to be located between the at least one support strip and the ring when the finger computer mouse is not in use.

14. A finger computer mouse as claimed in any one of claims 1 to 13, wherein the body has a lower face, a diode for light emission mounted within the body for generating a beam of light for passing directly through a first opening in the lower face and onto a surface for reflection by the surface; there being a second opening in the lower face, and an optical sensor mounted in the body adjacent the lower face for receiving the reflected beam through the second opening.

15. A finger computer mouse as claimed in claim 14, wherein the first opening and the second opening are formed into a single opening.

16. A finger computer mouse as claimed in any one of claims 1 to 15, further comprising a laser diode for generation of a laser beam for acting as a pointer.

17. A finger computer mouse as claimed in claim 3 or claim 9, wherein the pivot depends from the body.

18. A finger computer mouse as claimed in claim 3 or claim 9, wherein the pivot extends upwardly from an upper surface of the body.

19. A finger computer mouse as claimed in claim 17 or claim 18, wherein the pivot extends laterally of the body between the first end and the second end.

20. A finger computer mouse as claimed in any one of claims 17 to 19, wherein the pivot is of a height greater than the height of each of the first switch and the second switch.

21. A finger computer mouse as claimed in any one of claims 4, 5, 10 or 11, wherein there are two support strips.

22. A finger computer mouse as claimed in any one of claims 1 to 21, wherein the first switch depends from the body.

23. A finger computer mouse as claimed in any one of claims 1 to 22, wherein the second switch depends from the body.

24. A finger computer mouse as claimed in any one of claims 1 to 21, wherein the first switch extends upwardly from the body.

25. A finger computer mouse as claimed in any one of claims 1 to 21, wherein the second switch extends upwardly from the body.

26. A finger computer mouse as claimed in any one of claims 1 to 25, wherein the first end and the second end act as a pivot for the finger.

27. A finger computer mouse as claimed in claim 26, wherein the first end and the second end each have a cowling that comprises the pivot at the first end and the second end respectively.

28. A finger computer mouse as claimed in any one of claims 1 to 27, wherein the first switch extends upwardly from an upper surface of the body.

29. A finger computer mouse as claimed in any one of claims 1 to 27, wherein the second switch extends upwardly from an upper surface of the body.

30. A finger computer mouse as claimed in any one of claims 1 to 27, wherein the at least one support strip extends over an upper surface of the body.
